(19) United States
(12) Patent Application Publication
(10) Pub. No.: US 2022/0248734 A1
(43) Pub. Date: Aug. 11, 2022

(54) NUTRITIONAL HEALTH SUPPLEMENTS

(71) Applicant: MAYO FOUNDATION FOR MEDICAL EDUCATION AND RESEARCH, Rochester, MN (US)

(72) Inventor: David W. DODICK, Scottsdale, AZ (US)

(73) Assignee: MAYO FOUNDATION FOR MEDICAL EDUCATION AND RESEARCH, Rochester, MN (US)

(21) Appl. No.: 17/595,733

(22) PCT Filed: Mar. 19, 2020
(86) PCT No.: PCT/US2020/023696

§ 371 Date: Nov. 23, 2021

Related U.S. Application Data
(60) Provisional application No. 62/853,520, filed on May 28, 2019.
(60) Provisional application No. 62/915,768, filed on Oct. 16, 2019.
(60) Provisional application No. 62/947,729, filed on Dec. 13, 2019.

(51) Int. Cl. A23L 33/12; A23L 33/16; A23L 33/15; A23L 33/175

(52) U.S. Cl. CPC A23L 33/12; A23L 33/175; A23L 33/15; A23L 33/16

(57) ABSTRACT

A nutritional health supplement is provided for the brain. In one exemplary embodiment, a nutritional health supplement comprises an antioxidant that delays neuronal death under excitotoxic conditions, a neuroprotective agent having antioxidant, anti-inflammatory, and anti-apoptic properties, and a neuroprotective agent that is a precursor for glutathione synthesis. In another exemplary embodiment, a nutritional health supplement comprises an antioxidant that delays neuronal death under excitotoxic conditions, a neuroprotective agent that is a precursor for glutathione synthesis, a NAD+ precursor, a ketone body or ketone precursor, and an antioxidant with free-radical species-deactivating properties.

### CROSS-REFERENCE TO RELATED APPLICATION

This application is a U.S. National-Stage entry under 35 U.S.C. § 371 based on International Application No. PCT/US2020/023696, filed Mar. 19, 2020, which was published under PCT Article 21(2) and which claims priority to U.S. Provisional Application No. 62/853,520, filed May 28, 2019, U.S. Provisional Application No. 62/915,768, filed Oct. 16, 2019, and U.S. Provisional Application No. 62/947,729 filed Dec. 13, 2019, all herein incorporated by reference in their entireties.

### TECHNICAL FIELD

The technical field generally relates to nutritional health supplements, and more particularly to nutritional health supplements for the brain.

### BACKGROUND

The brain is the center of the nervous system in all vertebrates and most invertebrates. As the core of the nervous system and the organ that governs the function of all other organs, less than optimum or diminished brain function impacts all aspects of health and well-being. Accordingly, brain health maintenance and re-enforcement of brain defense mechanisms, which include short- and long-term support of the brain's fight against neuroinflammation, is a key component to maintaining and further enhancing health and well-being. Neuroinflammation is inflammation of nervous tissue, including the brain and spinal cord, and is initiated by many different conditions, diseases and injuries that affect the brain such as concussion, stroke, cancer, infections of blood, brain, and other organs, autoimmunity and autoimmune brain diseases including multiple sclerosis and other demyelinating diseases, migraine and other primary and secondary headache disorders, neurodegenerative diseases including Parkinson's Disease, Huntington's Disease and Amyotrophic Lateral Sclerosis and other motor neuron diseases, and dementia syndromes, including Alzheimer's Disease and Chronic Traumatic Encephalopathy.

Concussion, typically defined as a mild traumatic brain injury, affects both the brain's structural and metabolic organization and provokes intense neuroinflammation. The symptoms, signs, and long-term consequences of neuroinflammation resulting from concussion derive from pathophysiological events at the cellular level. This multifaceted injury includes both a primary injury and secondary injury to the cellular constituents of the brain. It is considered that primary structural injury results in a loss of structural integrity and death to cells and axons. Prevention is typically the focus for avoidance or minimization of primary structural injury, although alternatives are also sought.

The secondary injury of concussion occurs due to multiple, parallel, interacting and inter-dependent biological reactions initiated by the primary injury. These pathophysiological events are immediate, cumulative, progressive, and cascading in nature, and can result in progressive degeneration of the meninges, cortical, grey, and white matter structures of the brain. These secondary injury reactions are considered to underlie the vulnerability to repeated concussions, persistence of symptoms in some individuals, the long-term neurological sequelae that may occur after single or repeated concussions, and the progressive neurodegeneration that may occur in some individuals.

Accordingly, it is desirable to support the brain's defense mechanisms that counter both the primary and secondary injury reactions of concussion and its potentially devastating short term and long-term effects. It is also desirable to support the brain's defense mechanisms that support the brain's fight against neuroinflammation to maintain and further enhance health and well-being. Furthermore, other desirable outcomes, features and characteristics will become apparent from the subsequent description, taken in conjunction with this background.

### SUMMARY

In accordance with an exemplary embodiment, a nutritional health supplement is provided that includes, but is not limited to, an antioxidant that delays neuronal death under excitotoxic conditions, a neuroprotective agent having antioxidant, anti-inflammatory, and anti-apoptic properties, and a neuroprotective agent that is a precursor for glutathione synthesis.

In accordance with another exemplary embodiment, a nutritional health supplement is provided that includes, but is not limited to, an antioxidant that delays neuronal death under excitotoxic conditions, a neuroprotective agent that is a precursor for glutathione synthesis, a NAD+ precursor, a ketone body or ketone precursor, and an antioxidant with free-radical species-deactivating properties.

In a further exemplary embodiment, a nutritional health supplement is provided that includes, but is not limited to, riboflavin, N-acetyl cysteine (NAC), nicotinamide riboside, betahydroxybutyrate or a betahydroxybutyrate precursor, and glutathione.

### BRIEF DESCRIPTION OF THE DRAWINGS

The various embodiments will hereinafter be described in conjunction with the following drawing figures, wherein like numerals denote like elements, and wherein:

FIG. 1 illustrates a series of complex secondary pathological cascades that that occur both sequentially and in parallel at the onset of concussion; and

FIG. 2 illustrates five interdependent pathological reactions that occur as a result of the initial cascades illustrated in FIG. 1;

FIG. 3 illustrates neuroinflammation as a reaction in the pathology of the brain injury that occurs immediately after concussion;

FIG. 4 illustrates the role riboflavin, as an example of an antioxidant that delays neuronal death under excitotoxic conditions, plays in treating concussion, in an exemplary embodiment;

FIG. 5 illustrates the role resveratrol, as an example of a neuroprotective agent having antioxidant, anti-inflammatory and anti-apoptic properties, plays in treating concussion, in an exemplary embodiment;

FIG. 6 illustrates the role N-acetyl cysteine (NAC), as an example of a neuroprotective agent that is a precursor for glutathione synthesis, plays in treating concussion, in an exemplary embodiment;

FIG. 7 illustrates the role a B3 vitamin, as a NAD+ precursor, plays in treating concussion, in an exemplary embodiment;

FIG. 8 illustrates the role a branched chain amino acid (BCAA) plays in treating concussion, in an exemplary embodiment;

FIG. 9 illustrates the role omega-3 fatty acid docosahexaenoic acid (DHA), as an example of a neuroprotective agent that mitigates glutamate-mediated excitotoxicity and calcium influx, plays in treating concussion, in an exemplary embodiment;

FIG. 10 illustrates the role betahydroxybutyrate (BHB), as an example of a ketone, plays in treating concussion, in an exemplary embodiment;

FIG. 11 illustrates the role tetrahydroxycurcumin, as an example of a mitochondrial dysfunction mitigator with antioxidant and anti-inflammatory properties, plays in treating concussion, in an exemplary embodiment; and

FIG. 12 illustrates the role glutathione, as an example of an antioxidant with free-radical species-deactivating properties, plays in treating concussion, in an exemplary embodiment.

### DETAILED DESCRIPTION

As used herein, the word exemplary means serving as an example, instance, or illustration. The following detailed description is merely exemplary in nature and is not intended to limit the invention or the application and uses of the invention. Any embodiment described herein as exemplary is not necessarily to be construed as preferred or advantageous over other embodiments. The embodiments described in this Detailed Description are exemplary embodiments provided to enable persons skilled in the art to make or use the invention and not to limit the scope. Furthermore, there is no intention to be bound by any expressed or implied theory presented in this document.

The use of numerical values in the various ranges specified in this application, unless expressly indicated otherwise, are stated as approximations as though the minimum and maximum values within the stated ranges were both preceded by the word “about”. Thus, slight variations above and below the stated ranges can be used to achieve substantially the same results as values within the ranges. Moreover, in the disclosure of these ranges, a continuous range is intended, covering every value between the minimum and maximum values, including the minimum and maximum end points of the range. In general, the term “about” means +/−10% from the stated value.

A nutritional health supplement is provided in accordance with an exemplary embodiment. In another exemplary embodiment, the nutritional health supplement is a nutritional brain supplement, and in yet another embodiment the nutritional health supplement is a brain supplement that contains ingredients that work in a complementary and symbiotic manner to treat the pathological reactions that result from concussion, otherwise referred to as a mild traumatic brain injury.

The natural products of the nutritional health supplement are safe and effective for neuroprotection, including, but not limited to, attenuation or mitigation of brain injury. This includes the attenuation or mitigation attributed to concussion, such as because of metabolic and inflammatory secondary injury events. In addition, the combination of supplement ingredients is designed and formulated to at least reduces, and typically prevents, the persistence of symptoms in vertebrates and most invertebrates, of injuries such as concussion. While the following description is directed to concussion, there is no intent to limit the application or use of the nutritional health supplement to only concussion and the application and use is applicable to numerous health and neurological conditions.

The pathological mechanisms initiated after concussion are immediate, cumulative, sequential, and in the cases of inflammation and neurodegeneration, persistent and progressive. Current attempts to investigate the treatment of concussion typically isolate and target a single mechanism of this complex, sequential, and progressive multi-modal injury and do not appreciate that the mechanisms result in a cascading effect wherein the mechanisms build on each other and display a temporal profile. As explained in more detail below, altered membrane and cellular ionic homeostasis leads to excitotoxicity with excessive release and reduced uptake of glutamate, calcium sequestration and mitochondrial dysfunction. Mitochondrial dysfunction leads to oxidative stress, the generation of reactive oxygen species, a reduction in energy production, the failure of membrane pumps, worsening ionic homeostasis, depletion of essential metabolites that are responsible for the production of neurotransmitters and neurotrophic factors, activation of genes that lead to programmed cell death, and eventually cell death. The primary and secondary neural injury results in microglial activation, the release of cytokines, and neuroinflammation. Neuroinflammation leads to axonal destruction, microtubule dissociation, tau aggregation and deposition which leads to cell death and further inflammation. These events have a temporal profile and may progress at different rates in different areas of the brain that are affected differentially by the diffuse and multifocal nature of the brain injury after the traumatic impact. The various embodiments of the nutritional health supplements contemplated herein comprise a unique combination of ingredients that are strategically selected to symbiotically interfere with each step in this cascade. Therefore, the embodiments have a synergistic effect, enhance the protection of uninjured but neighboring tissue, rescue vulnerable tissue that is destined for cell death and permanent injury, and enhance the repair of injured tissue.

In more detail, the pathogenesis of concussion is initially induced by a mechanical injury that sets into motion a series of complex secondary pathological mechanisms that occur both sequentially and in parallel. This cascade of sequential, interdependent and parallel pathological reactions is initiated immediately after the injury and can persist and progress over an indefinite period of time. The persistence of these mechanisms can lead to progressive neuronal, axonal, and glial cell death which can result in persistent symptoms and progressive neurodegeneration.

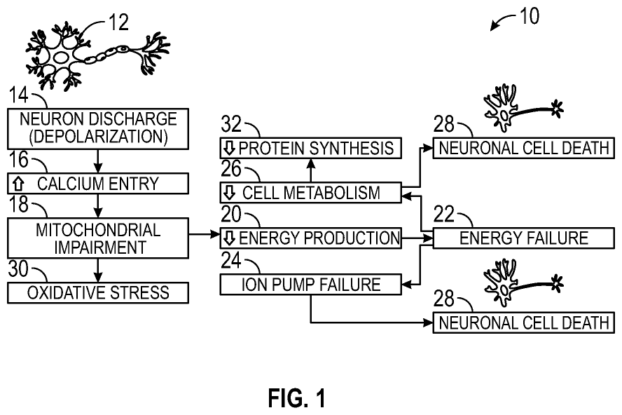

Referring to FIG. 1, the pathological cascade 10 begins with a diffuse, massive and unregulated depolarization 14 of neurons 12 leading to an efflux of potassium (K⁺) and an influx of sodium (Na⁺) and an influx of calcium (Ca⁺⁺) 16 into the neuron cells. To restore resting membrane potential and ionic concentration gradients, large amounts of adenosine triphosphate (ATP) are required to power Na⁺/K⁺ ATPase pumps. As a result, there is an upregulation of glucose metabolism via glycolytic pathways. However, decreased cerebral blood flow reduces the delivery of glucose to the cells with increased energy need, thus creating an energy crisis 22—a mismatch between supply and demand for energy within the brain. Reliance upon anaerobic metabolic pathways to meet the ATP demands on the cell results in an acute accumulation of lactate and local acidosis. While lactate can be a fuel source for neurons to help meet ATP demands, this process requires proper mitochondrial function and aerobic metabolism, which are compromised during concussion.

Continuing with FIG. 1, large concentrations of intracellular calcium lead to sequestration within mitochondria, mitochondrial dysfunction 18, impaired oxidative phosphorylation (oxidative stress) 30, and a reduction in ATP generation 20. This further exacerbates the energy crisis 22, a reduction in the function of pumps required to restore ionic homeostasis 24, continued influx of calcium into the cell, and impairment in vital cellular functions including DNA repair, DNA replication, and neurotransmitter and protein synthesis 32. These synthetic functions to maintain the metabolic and structural integrity of the cell, its dendritic and axonal elements, and the synaptic function of the cell and thus impairment of these functions results in degradation of the metabolic and structural integrity of the cell 26. Ultimately the result of this energy crisis is cellular death 28 and loss of the function and synaptic network of the cell.

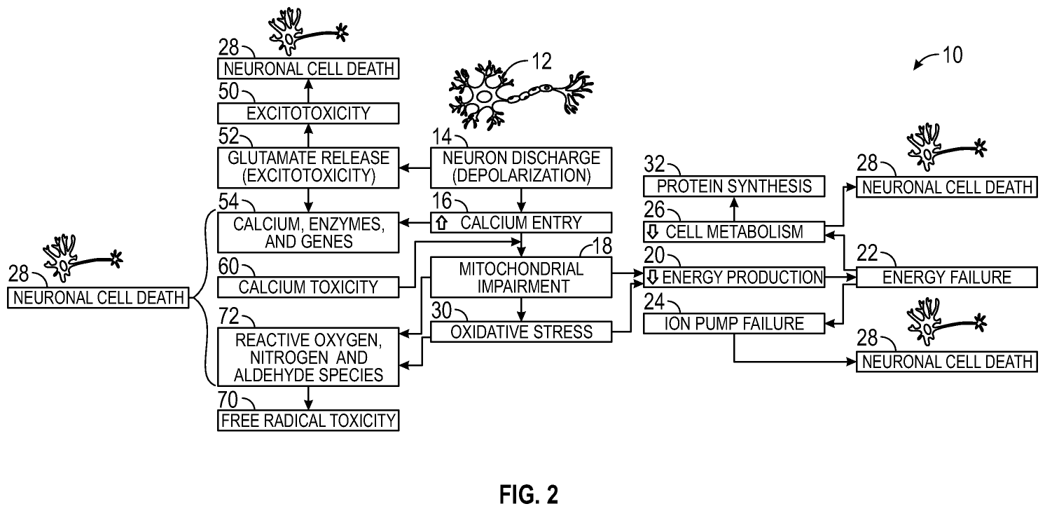

At least five interdependent pathological reactions occur as a result of the initial cascades of depolarization, calcium influx, and mitochondrial dysfunction/oxidative stress. These five reactions include excitotoxicity, calcium-mediated toxicity, free radical toxicity, neuroinflammation, and neurodegeneration. Referring to FIG. 2, the first reaction, excitotoxicity 50, is mediated by glutamate, which can result in cellular death. Massive depolarization 14 of neurons leads to the unregulated release 52 of glutamate, the brain's most abundant excitatory neurotransmitter. Excessive concentrations of glutamate in the synaptic and extracellular space results in overactivation of NMDA and AMPA receptors. This causes excitotoxicity 50 by allowing high levels of calcium ions 54 to enter the cell, further augmenting the influx of calcium 16 caused by the initial depolarization of the cell 14.

Calcium-mediated toxicity 60 is mediated by activation of a number of enzymes 54, including phospholipases, endonucleases, and proteases such as calpain, which damage the cell membrane, the cytoskeleton of the cell, and DNA. This calcium influx also activates apoptosis genes 54, normally responsible for programmed cell death, which now results in premature cell death 28.

Free radical toxicity 70 is characterized by the production of reactive oxygen species 72 (ROS) and reactive nitrogen species (RNS), including free radicals, peroxide, and superoxide, as a result of mitochondrial dysfunction 18 and oxidative stress 30. In addition to the generation of these oxidizing molecules, oxidative stress 30 may also be associated with a significant decrease in the effectiveness of antioxidant defenses, including and especially glutathione. The harmful effects of ROS on the cell include damage to DNA, RNA and proteins, lipid peroxidation (oxidation of free fatty acids and membrane lipids), and induction of apoptosis or programmed cell death. Lipid peroxidation leads to the production of reactive aldehydes 72 such as malondialdehyde and 4-hydroxynonenal, the latter of which causes damage to cellular constituents similar to ROS. Overall, while cells can overcome the negative effects associated with oxidative stress if the disturbance is mild, moderate or severe oxidative stress, as may occur after concussion, can trigger apoptosis, cell death, or cell necrosis.

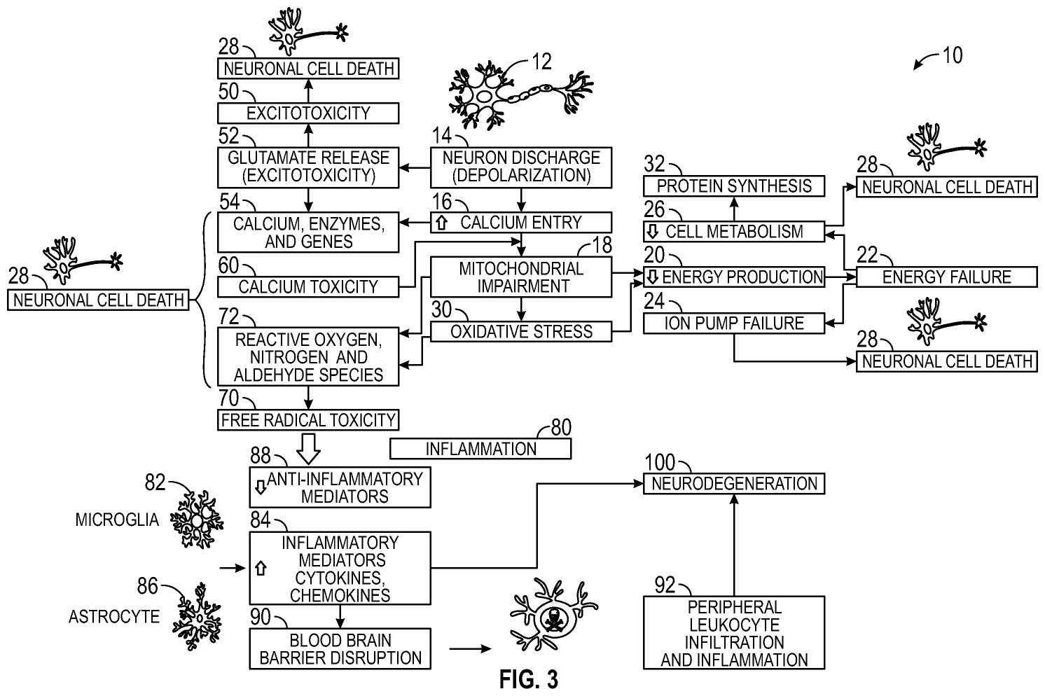

Referring to FIG. 3, neuroinflammation (illustrated in FIG. 3 as “Inflammation”) 80 plays a significant role in the pathology of the brain injury that occurs immediately after concussion. Neuroinflammation 80 can last for years after the initial injury, especially in the setting of repetitive head impacts/repeated concussions. Repetitive head impacts may lead to chronic neuroinflammation that induces a self-perpetuating inflammatory cycle with longstanding activation of microglia 82, including sustained release of inflammatory mediators 84. Neuroinflammation-induced secondary injury after TBI has been linked to chronic proinflammatory cytokines that are produced mainly by microglia. Other cells, especially astrocytes 86, but also to some extent neurons and endothelial cells, can also produce proinflammatory cytokines. This can produce a positive feedback loop since the proinflammatory cytokines activate glial cells. The excessive production of proinflammatory mediators exacerbates brain damage, impedes brain repair, and not only hinders functional neurological recovery, but also leads to progressive injury that can lead to persistent and progressive symptoms and neurological impairment. Proinflammatory cytokines including interleukin 1 beta (IL-1b), IL-6, IL-17, tumor necrosis factor-a (TNF-a), and interferon-g (IFN-g) increase after concussion. There is also a significant increase in chemokines including macrophage chemotactic protein-1 (MCP-1), macrophage inflammatory protein 2 (MIP-2), and chemokine (C—C motif) ligand 5 (CCL5). This inflammatory cascade is exacerbated by the reduction in levels of anti-inflammatory cytokines 88 such as IL-4, IL-10, IL-13, and transforming growth factor-b1 (TGF-b1). In addition, because of a disruption in the blood brain barrier 90, peripheral macrophages can infiltrate the brain 92, transform into microglia 82, and exacerbate the ongoing native inflammatory response in the brain.

With continued reference to FIG. 3, these parallel and interdependent reactions may ultimately lead to energy failure 22 within the cell, a loss of synthetic function (proteins production) 32, proper ion channels function 24, neurotransmitter production, and DNA replication and repair), and neurodegeneration 100 and death of the brain cell 28.

Head injury, concussion, and repetitive head impacts have been demonstrated to be a major risk factor for Alzheimer's disease, dementia, and tauopathies, including Chronic Traumatic Encephalopathy (CTE). All of the pathological cascades described above may lead to the breakdown and destruction of the cytoskeletal architecture of axons and dendrites, including the microtubules that are responsible for axonal transport of neuropeptides and neurotransmitters that are responsible for synaptic communication between neurons. Persistent inflammation after concussion and repetitive head impacts also may lead to progressive neurodegenerative disease. Neuroinflammation is detectable in the earliest stages of Alzheimer's disease. The neuronal toxicity associated with inflammation makes it a potential mediator in the pathogenesis of Alzheimer's disease. Injured neurons also lead to further glial activation and a feed-forward cycle of glial activation and neuronal injury resulting in progressive neurodegeneration leading to the development of Alzheimer's disease or CTE in predisposed individuals.

Neuroinflammatory cytokines and reactive microglia exacerbate tau pathology and contribute to the spreading of tau in animal models of Alzheimer disease and other tauopathies, including CTE. Increased neuroinflammation, including an increase in inflammatory cell (CD68) density and enhanced microglia reactive morphology is associated with more severe tau pathology in the cortex of humans with neuropathologically diagnosed CTE. Increased neuroinflammation is also related to the risk of being diagnosed with dementia and this relationship is mediated by tau. Increased neuroinflammation as a consequence of concussion, especially after repetitive head impacts, appears to play an important role in the development of tau pathology in CTE. The interdependence of the various cascades involved in the brain injury after concussion is underscored by the participation of reactive oxygen species (ROS) and calcium-induced activation of calpain, caspases, and apoptosis genes in neuroinflammation and neurodegeneration. The cleavage of tau by Caspases results in aggregation of tau fragments which promote neuronal injury and neurodegeneration.

In the setting of a diffuse injury, as exists after concussion, a neuron in one location may differ from a neuron in another location with regard to the evolution of this pathological cascade. It is therefore imperative that a treatment contain various ingredients that target different mechanisms at different stages in this pathological cascade. This prevents later stage pathological mechanisms from being initiated if the sequence is terminated early and rescues other cells that may already be in a later stage of this pathological cascade. A treatment that contains various ingredients that target different mechanisms at different stages in this pathological cascade therefore will act in a complementary and synergistic fashion.

Accordingly, in an exemplary embodiment, a nutritional health supplement includes, but is not limited to, an antioxidant that delays neuronal death under excitotoxic conditions, a neuroprotective agent having antioxidant, anti-inflammatory and anti-apoptic properties, and a neuroprotective agent that is a precursor for glutathione synthesis. In another exemplary embodiment, a nutritional health supplement includes, but is not limited to, an antioxidant that delays neuronal death under excitotoxic conditions, a neuroprotective agent that is a precursor for glutathione synthesis, a NAD+ precursor, a ketone body or ketone precursor, and an antioxidant with free-radical species-deactivating properties.

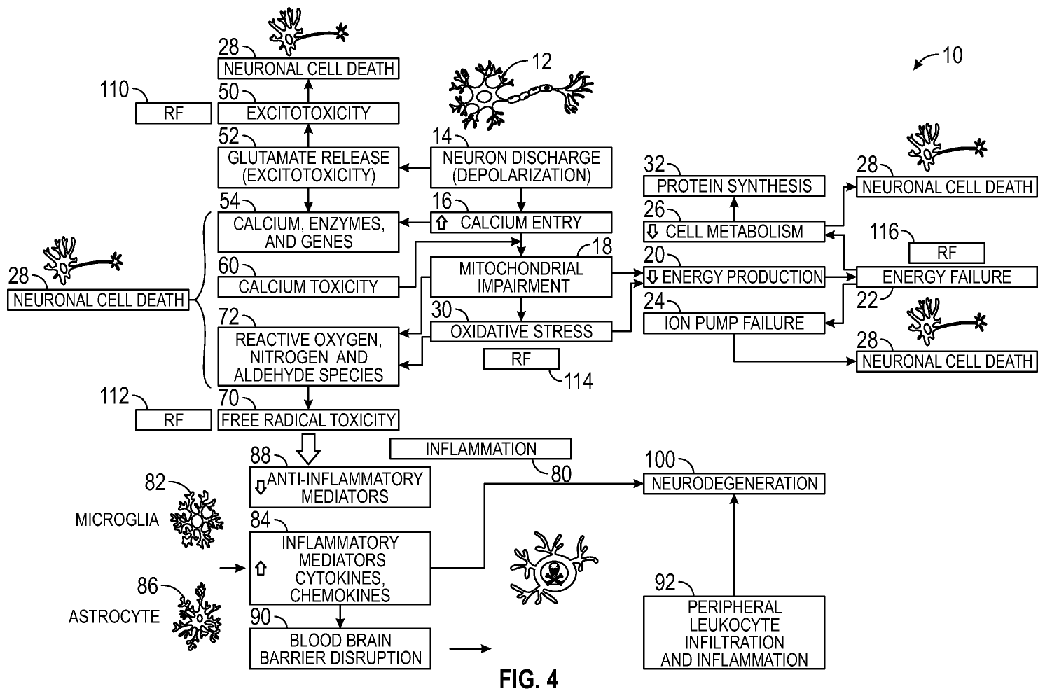

In an exemplary embodiment, the antioxidant that delays neuronal death under excitotoxic conditions comprises riboflavin. Riboflavin is a B-vitamin and powerful antioxidant. It is readily absorbed and is required for normal cellular functioning. As illustrated in FIG. 4, riboflavin delays neuronal death under excitotoxic conditions 110, its metabolites act as electron carriers in biochemical oxidations and reductions 112, and it mitigates against oxidative damage 114 and facilitates energy production 116. Riboflavin attenuates injury size and the activation of reactive astrocytes 118 and has been shown in experimental concussion models to result in substantial functional recovery in sensorimotor function and working spatial memory. In an exemplary embodiment, the riboflavin comprises riboflavin-5′-phosphate. Riboflavin-5′-phosphate is the main form of riboflavin found in cells. It is produced from riboflavin. Compared to riboflavin, it requires more energy to produce and is more soluble. While riboflavin, and particularly riboflavin-5′-phosphate, are identified herein as examples of an antioxidant that delays neuronal death under excitotoxic conditions, it will be appreciated that any antioxidant that is capable of delaying neuronal death under excitotoxic conditions is contemplated herein.

In an exemplary embodiment, a daily dose of the nutritional health supplement includes riboflavin in an amount of about 100 mg to about 600 mg, for example, about 150 mg to about 550 mg, such as about 200 mg to about 500 mg. In another exemplary embodiment, riboflavin is present in a daily dose of the nutritional health supplement contemplated herein in an amount of about 250 mg to about 450 mg, for example, about 300 mg to about 400 mg, such as about 400 mg.

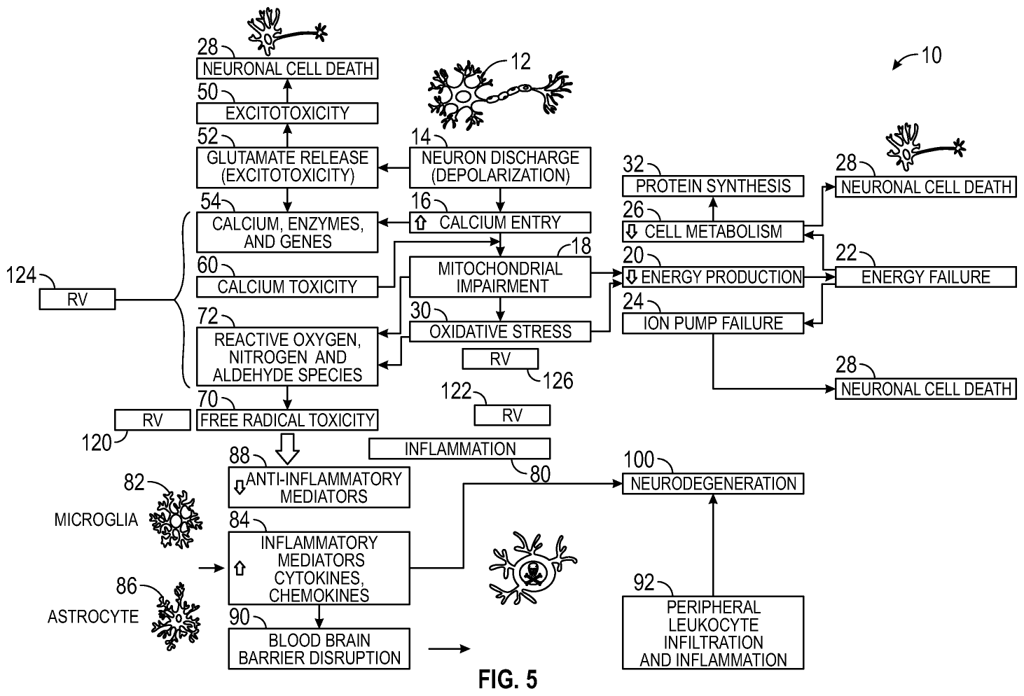

As noted above, in another embodiment, the nutritional supplement comprises a neuroprotective agent having antioxidant, anti-inflammatory and anti-apoptic properties. While any neuroprotective agent having antioxidant, anti-inflammatory and anti-apoptic properties is contemplated herein, an example of a suitable neuroprotective agent having antioxidant, anti-inflammatory and anti-apoptic properties comprises resveratrol. Resveratrol (3,5,40-trihydroxystilbene, RV) is a natural polyphenol belonging to the phytoalexin family that is found in grapes and a variety of medicinal plants. Resveratrol facilitates a wide spectrum of biological functions and exerts protective effects against neurological damage, including stroke, spinal cord injury and neurodegenerative diseases. Referring to FIG. 5, neuroprotection in central nervous system injury models are associated with its antioxidant 120, anti-inflammatory 122, and anti-apoptotic 124 properties. Immediately after concussion, resveratrol reduces oxidative stress 126 and lesion volume and diminishes brain swelling and neuronal death, while increasing recovery of proteins and enhancing cognitive functional recovery.

Two brain structures prominently affected in head trauma are the cortex and the hippocampus, which play a role in the processing of spatial memory and learning. The loss of neurons in the hippocampus contributes to the impairment of learning and memory following concussion. Thus, impairment of cognitive function has long been thought to be the result of rapid cell death following concussion. Concussion increases neuronal cell death in both the hippocampus and leads to long-term neurobehavioral effects of trauma-increased anxiety and deterioration of cortex and hippocampal-dependent memory. Resveratrol administration after the trauma ameliorates the histopathological and behavioral consequences of trauma, especially in the hippocampus.

In an exemplary embodiment, resveratrol is present in a daily dose of the nutritional health supplement contemplated herein in an amount of about 250 mg to about 500 mg, for example, about 300 mg to 500 mg, such as about 350 mg to 500 mg. In another exemplary embodiment, resveratrol is present in a daily dose of the nutritional health supplement contemplated herein in an amount of about 400 mg to about 500 mg, for example, about 450 mg.

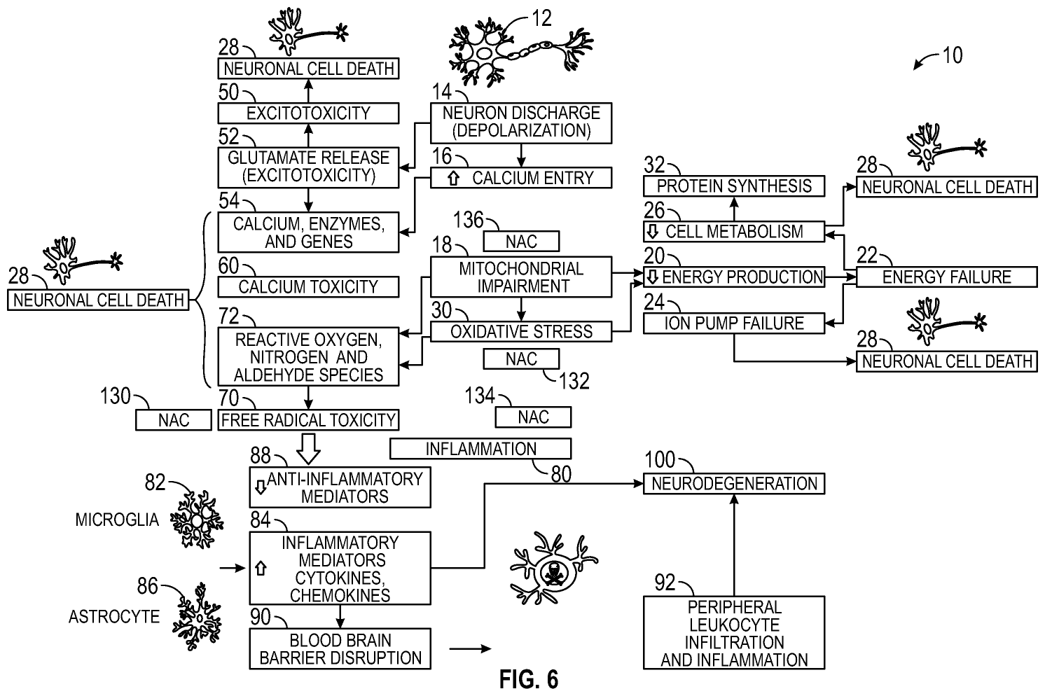

The nutritional supplement further comprises a neuroprotective agent that is a precursor for glutathione synthesis in accordance with an embodiment, as noted above. N-acetyl cysteine or N-acetyl L-cysteine (NAC) is an example of a neuroprotective agent suitable for use in the nutritional supplement contemplated herein. NAC exerts neuroprotective effects that are mediated by antioxidant and anti-inflammatory effects. Without wishing to be bound by theory, the antioxidant and anti-inflammatory effects of NAC are likely the result of inhibition of NAC-induced nuclear factor-κB-activated pathways that include cytokine cascades and phospholipid metabolism. NAC also appears to preserve mitochondrial function, particularly in hippocampal neurons. Referring to FIG. 6, NAC is also a precursor for the synthesis of glutathione (GSH), which is an essential and critical intracellular antioxidant that protects neurons against free radical damage in the brain by both sequestering and preventing the formation of oxygen free radicals 130. As noted above, reactive oxygen species (ROS) and nitrogen species (RNS) are overproduced after concussion secondary to mitochondrial dysfunction 18 and neuroinflammation 80 as a result of activated microglia 82 and astrocytes 86. These free radicals can cause cellular damage and death by targeting lipid membranes, DNA, and proteins, and are responsible in part for the secondary injury that occurs after a concussion. Concussion also leads to a reduction in endogenous antioxidants, notably, glutathione. In the immediate period after concussion, glutathione protects the blood brain barrier, prevents meningeal and parenchymal brain cell death, and neuroinflammation 134 after concussion. NAC can significantly elevate GSH levels in the brain following oxidative stress, thus reducing mitochondrial impairment 136 and oxidative stress 132. While NAC has limited capability to cross the normal blood-brain barrier, the blood-brain barrier is disrupted in some individuals after concussion. Moreover, glutathione can cross the blood-brain barrier, enter the brain and exert neuroprotective activity. Receiving NAC within a relatively short period of time of a brain injury (within 24 hours of head injury from a blast) significantly increases symptom resolution with no reported side effects. While NAC is identified herein as an example of a neuroprotective agent that is a glutathione-synthesis precursor, it will be appreciated that any neuroprotective agent or ingredient that is a precursor for glutathione synthesis is contemplated herein.

In an exemplary embodiment, NAC is present in a daily dose of the nutritional health supplement contemplated herein in an amount of about 400 mg to about 4000 mg, for example, about 400 mg to about 3500 mg, such as about 400 mg to about 3000 mg. In another exemplary embodiment, NAC is present in a daily dose of the nutritional health supplement contemplated herein in an amount of about 400 mg to about 2500 mg, for example, about 400 mg to about 2,000 mg, such as about 400 mg to about 1500 mg. In another exemplary embodiment, NAC is present in a daily dose of the nutritional health supplement contemplated herein in an amount of about 500 mg to about 1300 mg, for example, about 600 mg to about 1200 mg.

In accordance with another exemplary embodiment, the nutritional health supplement as contemplated herein includes, but is not limited to, a NAD+ precursor. Examples of NAD+ precursors suitable for use in the nutritional supplement contemplated herein include niacin, nicotinamide (NAM), and nicotinamide riboside (NR). All tissues produce NAD+ from nicotinamide (NAM) or the recently identified NAD+ precursor, NR. Niacin, NAM and NR are neuroprotective soluble B3 vitamins that improve recovery of neurological function after brain injury.

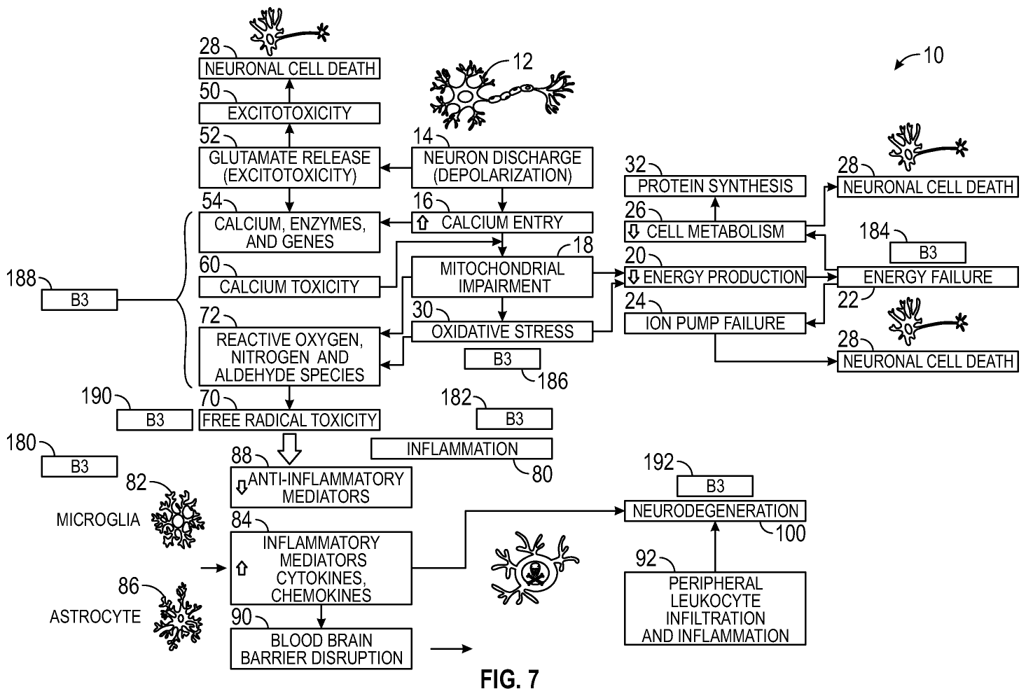

NAD+ is the reduced version of the coenzyme nicotinamide adenine dinucleotide (NAD). The NAD coenzymes NAD+, NADH, NADP+ and NADPH are the central regulators of metabolism and are required for fuel oxidation, ATP generation, gluconeogenesis, ketogenesis, production of pentose phosphates, heme, lipids, steroid hormones and detoxification of free radical species. The reduction of NAD+ in the post-concussion period reduces the production of brain derived neurotrophic factor (BDNF) by silencing its gene. BDNF is the brain's primary neurotrophic factor and is responsible for promoting growth, differentiation, survival, and expansion of neurons and is implicated in synaptic plasticity and neuroplasticity. It is therefore beneficial in the neural repair and neuroplasticity required for recovery from concussion. NAD+ is important in regulating ATP synthesis in the brain and in the recovery process after brain trauma, since ATP is required to power the membrane Na+/K+ ATPase pumps that restore ionic homeostasis and membrane potential that are necessary for the recovery and survival of cells after concussion. Neuronal death from concussion occurs in part due to the excessive activation of poly (ADP-ribose) polymerase-1 (PARP-1), which results in NAD+ depletion and energy failure. As illustrated in FIG. 7, the administration of a B3 NAD+ precursor after concussion, for example shortly or immediately after brain injury, protects neurons in the hippocampus and delays microglial activation 180 and neuroinflammation 182, provides fuel generation 184, mitigates oxidative stress 186, free radical toxicity 190 and calcium-mediated toxicity 188, and minimizes neurodegeneration 192.

Different enzymatic pathways, which are expressed to variable degree in different cell types, are responsible for converting each of the forms of vitamin B3 into NAD+. These enzymatic pathways also respond differently to cellular stress. In preclinical studies of concussion, the enzyme nicotinamide phosphoribosyl transferase (Nampt) that catalyzes the conversion of nicotinamide to NAD+, is inhibited after concussion, whereas the expression of the enzymes NRK1 and NRK2 that convert NR to NAD+ is increased. This increased expression occurs in injured central and peripheral neurons. As a result, NR increases NAD+ levels to a degree that is not possible with niacin and nicotinamide.

In addition, while nicotinamide is an NAD+ precursor, it also inhibits the activity of sirtuins. Sirtuins are a family or proteins that play a role in energy metabolism, stress resistance, inflammation, aging, DNA repair, and programmed cell death. On the other hand, NR increases the activity of sirtuins and may therefore enhance neuroprotection beyond what is achievable with niacin and nicotinamide.

In an exemplary embodiment, NR is present in a daily dose of the nutritional health supplement contemplated herein in an amount of about 300 mg to about 1,000 mg, for example, about 350 mg to about 950 mg, such as about 400 mg to about 900 mg. In another exemplary embodiment, NR is present in a daily dose of the nutritional health supplement contemplated herein in an amount of about 450 mg to about 850 mg, for example about 500 mg to about 800 mg, such as about 500 mg to about 750 mg.

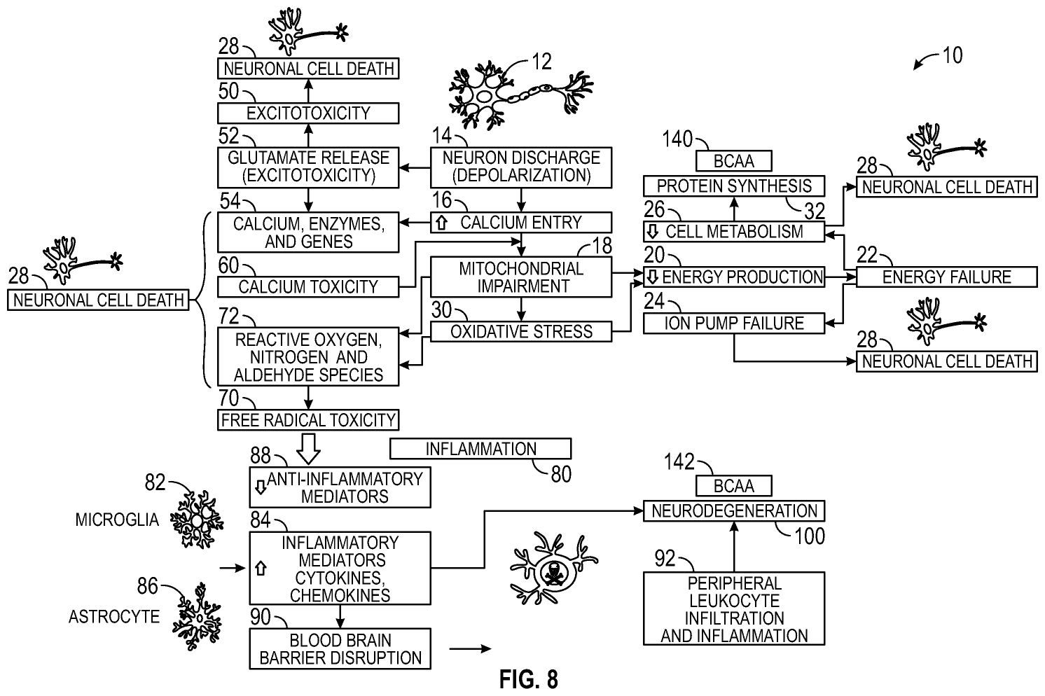

The nutritional health supplement contemplated herein includes, but is not limited to, a branched chain amino acid (BCAA), in accordance with an exemplary embodiment. Referring to FIG. 8, the BCAA, such as, for example, L-leucine, L-isoleucine, L-valine, and combinations thereof, serve as metabolic precursors in the brain and are required by the brain for the synthesis of proteins, neurotransmitters and essential brain metabolites 140. The blood concentration of BCAAs rise rapidly in proportion with the amount of ingested BCAAs, and, unlike other amino acids, undergo minimal first-pass metabolism. BCAAs are transported across the blood-brain barrier and are therefore readily available to the brain.

Clinical studies have demonstrated that endogenous levels of BCAAs are reduced in individuals that sustain a concussion relative to healthy controls, suggesting that the metabolic cascade that ensues after brain injury influences BCAA metabolism. Concussion alters BCAA levels and the BCAA supplementation of the nutritional health supplement contemplated herein positively influences concussion recovery with no adverse side. The proteins derived from BCAAs also serve to maintain the integrity of the transport machinery that allow for axonal and dendritic transport of neurotransmitters that become compromised as a result of the inflammatory cascades that occur after concussion. The neurotransmitter proteins generated from BCAAs also maintain the integrity of synaptic connections and therefore of the neural network. In this way, BCAAs mitigate the compromise to neuronal function imposed by multiple pathological mechanisms that occur after concussion 142.

In an embodiment, the BCAA, which can be, for example, L-leucine or other branched chain amino acids, is present in a daily dose of the nutritional supplement contemplated herein in an amount of about 1 mg to 5,000 mg, for example, about 100 mg to about 4,500 mg, such as about 200 mg to about 4,400 mg. In another embodiment, the BCAA is present in a daily dose of the nutritional supplement contemplated herein in an amount of about 300 mg to about 4,300 mg, for example, about 400 mg to about 4,200 mg, such as about 500 mg to about 4,100 mg. In another embodiment, the BCAA is present in a daily dose of the nutritional supplement contemplated herein in an amount of about 700 mg to about 3,900 mg, for example about 800 mg to about 3,800 mg, such as about 900 mg to about 3,700 mg. In another embodiment, the BCAA is present in a daily dose of the nutritional supplement contemplated herein in an amount of about 1,000 mg to about 3,600 mg, for example, about 1,100 mg to about 3,500 mg, such as about 1,200 mg to about 3,400 mg. In another embodiment, the BCAA is present in a daily dose of the nutritional supplement contemplated herein in an amount of about 1,300 mg to about 3,300 mg, for example, about 1,400 mg to about 3,200 mg, such as about 1,500 mg to about 3,100 mg, In another embodiment, the BCAA is present in a daily dose of the nutritional supplement contemplated herein in an amount of about 1,600 mg to about 3,000 mg, for example, about 1,700 mg to about 2,900 mg, such as about 1,800 mg to about 2,800 mg. In another embodiment, the BCAA is present in a daily dose of the nutritional supplement contemplated herein in an amount of about 1,900 mg to about 2,700 mg, for example, about 2,000 mg to about 2,600 mg, such as about 2,100 mg to about 2,500 mg. In another embodiment, the BCAA is present in a daily dose of the nutritional supplement contemplated herein in an amount of about 2,200 mg to about 2,300 mg, for example, about 2,225 mg to about 2,275 mg, such as about 2,500 mg.

In another exemplary embodiment, the BCAA, which can be, for example, L-valine, L-isoleucine, a combination thereof, or other branched chain amino acids, is present in a daily dose of the nutritional supplement contemplated herein in an amount of about 1 mg to about 2,500 mg, for example about 50 mg to about 2,450 mg, such as about 100 mg to about 2,400 mg, In another embodiment, the BCAA is present in a daily dose of the nutritional supplement contemplated herein in an amount of about 150 mg to about 2,350 mg, for example, about 200 mg to about 2,300 mg, such as about 250 mg to about 2,250 mg. In another embodiment, the BCAA is present in a daily dose of the nutritional supplement contemplated herein in an amount of about 300 mg to about 2,200 mg, for example, about 350 mg to about 2,150 mg, such as about 400 mg to about 2,100 mg. In another embodiment, the BCAA is present in a daily dose of the nutritional supplement contemplated herein in an amount of about 450 mg to about 2,050 mg, for example, about 500 mg to about 2,000 mg, such as about 550 mg to about 1,950 mg. In another embodiment, the BCAA is present in a daily dose of the nutritional supplement contemplated herein in an amount of about 600 mg to about 1,900 mg, for example, about 650 mg to about 1,850 mg, such as about 700 mg to about 1,800 mg. In another embodiment, the BCAA is present in a daily dose of the nutritional supplement contemplated herein in an amount of about 750 mg to about 1,750 mg, for example, about 800 mg to about 1,700 mg, such as about 850 mg to about 1,650 mg. In another embodiment, the BCAA is present in a daily dose of the nutritional supplement contemplated herein in an amount of about 900 mg to about 1,600 mg, for example, about 950 mg to about 1,550 mg, such as about 1,000 mg to about 1,500 mg. In another embodiment, the BCAA is present in a daily dose of the nutritional supplement contemplated herein in an amount of about 1,050 mg to about 1,450 mg, for example, about 1,100 mg to about 1,400 mg, such as about 1,150 mg to about 1,350 mg. In another embodiment, the BCAA is present in a daily dose of the nutritional supplement contemplated herein in an amount of about 1,200 mg to about 1,300 mg, for example, about 1,225 mg to about 1,275 mg, such as about 1,250 mg.

In accordance with an exemplary embodiment, the nutritional supplement contemplated herein includes, but is not limited to, a neuroprotective agent that mitigates glutamate-mediated excitotoxicity and calcium influx. In one embodiment, the neuroprotective agent is an omega-3 fatty acid. In another embodiment, the neuroprotective agent is the omega-3 fatty acid docosahexaenoic acid (DHA). While the neuroprotective agent will be described below with reference to DHA, it will be appreciated that other neuroprotective agents that mitigate glutamate-mediated excitotoxicity and calcium influx may be suitable for use in the nutritional supplement contemplated herein.

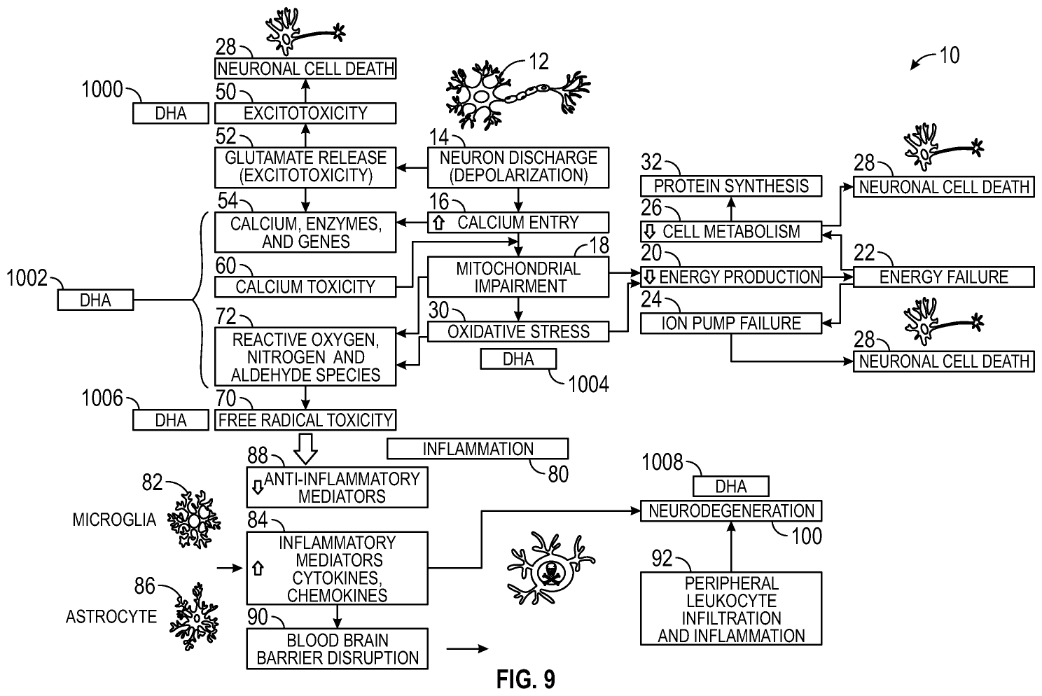

DHA is an omega-3 long-chain polyunsaturated fatty acid (LCPUFA) that is highly concentrated in the central nervous system (CNS). As illustrated in FIG. 9, DHA protects against several pathophysiological reactions after concussion, including glutamate-mediated excitotoxicity 1000, calcium influx 1002, mitochondrial dysfunction and oxidative stress 1004, and the calcium mediated and free radical mediated toxicity that occurs as a result of this upstream reactions 1006.

The neuronal content of DHA is reduced after concussion and the structural injury, neuronal death, and neurological consequences of a concussion increase when neuronal levels of DHA are low. Prophylactic supplementation with DHA mitigates brain white matter damage and enhances the protection of the cytoskeletal elements and architecture of brain axons after a concussion 1008. DHA mitigates against the neuronal and axonal damage after concussion as measured by serum neurofilament light, a highly sensitive and specific biomarker for concussion-related brain injury. Further, animals supplemented with DHA demonstrate enhanced resilience to concussion and multiple TBIs, similar to that which would be observed in repetitive sports-related concussive injuries.

Physical activity, particularly that which is long in duration and high in intensity, affects plasma phospholipid composition, which is an important consideration for athletes. The neuroprotective effects of supplemental DHA demonstrate the greatest efficacy when administered at a dose of approximately 3.6 g in a 90-kg athlete. While athletes with greater height, weight, and body mass index, including American Football players, may require a higher dose, athletes of smaller stature and body mass may only require about 2 g/day.

In an exemplary embodiment, DHA is present in a daily dose of the nutritional health supplement contemplated herein in an amount of about 200 mg to about 4,000 mg, for example, about 700 mg to about 3,500 mg, such as about 1,200 mg to about 3,000 mg. In another exemplary embodiment, DHA is present in a daily dose of the nutritional health supplement in an amount of about 1,700 mg to about 3,500 mg, for example, about 2,000 mg to about 3,000 mg, such as about 2,000 mg to about 2,500 mg. In another exemplary embodiment, DHA is present in a daily dose of the nutritional health supplement in an amount of about 2,000 mg.

In accordance with another exemplary embodiment, the nutritional health supplement as contemplated herein includes, but is not limited to, a ketone body or ketone precursor. Ketone bodies (ketones), such as beta-hydroxybutyrate (BHB), acetoacetate, and acetone, or ketone precursors, such as ketone salts, for example, sodium, potassium, magnesium and/or calcium salts of BHB, and ketone esters, such as D-beta-hydroxybutyrate/D-1,3-butanediol and acetoacetate/D/L 1,3-batanediol, represent an alternative to glucose for cerebral metabolism and are the only endogenous fuels that can contribute significantly to cerebral energy metabolism. Cerebral metabolism of glucose has been demonstrated to be altered after concussion and elevated levels of glucose has been associated with poor outcome after concussion. Ketones have been demonstrated to be neuroprotective in several models of concussion. Ketones alter and improve mitochondrial metabolism and their oxidation generates more ATP than glucose or fatty acid metabolism, while also generating fewer reactive oxygen species (ROS).

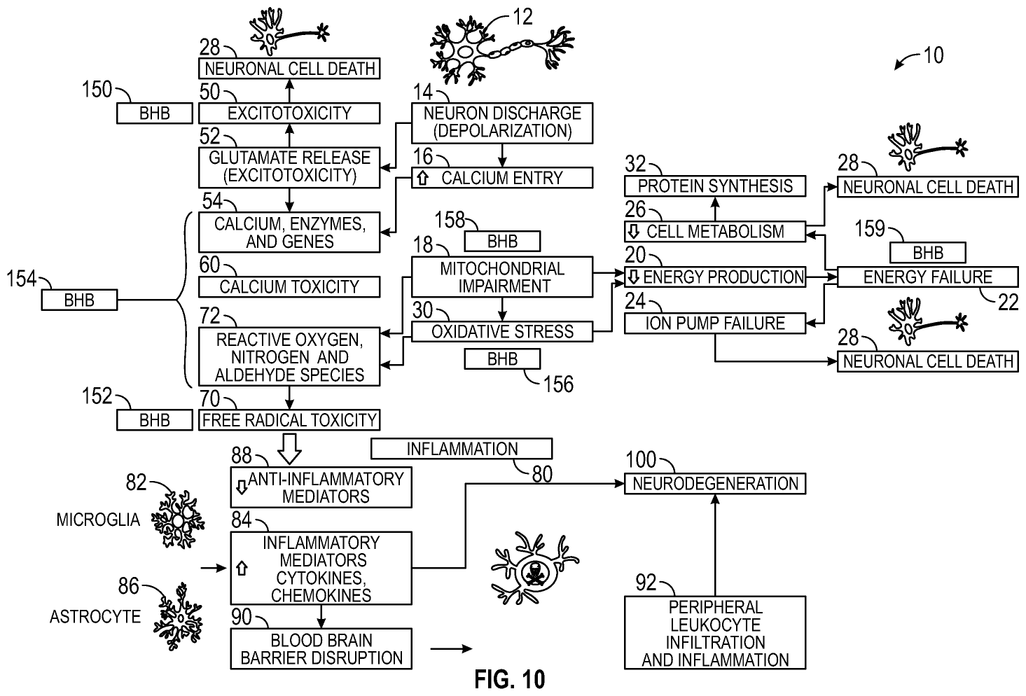

In animal studies evaluating the ketogenic diet (KD) for concussion, ketones have been shown to increase ATP, decrease neuronal death, decrease edema, and improve cell survival under stressful conditions of ischemia and hypoxia. Ketones also decrease glutamate synthesis, reduce apoptosis (programmed cell death), and increase brain-derived neurotrophic factor. These metabolic properties of ketones are thought to contribute to their neuroprotective potential after concussion and other traumatic brain injuries. The administration of exogenous ketones, in the form of ketone esters or salts, represents a treatment strategy to rapidly increase ketones in the body to be used an energy source for cerebral metabolism and as treatment to reduce the inflammation and anti-excitotoxity while improving cerebral blood flow and energy production after a concussion. Moreover, studies suggest that after acute brain injury, cerebral uptake of ketones increases significantly, and there is both experimental and clinical evidence that administering ketones to patients with cerebral injury may provide significant benefit. While the ketone body will be described below with reference to BHB, it will be appreciated that other ketone bodies and precursors may be suitable for use in the nutritional supplement contemplated herein. It is to be appreciated herein that reference to BHB herein also refers to BHB precursors. Referring to FIG. 10, BHB is the major ketone produced by the body and serves as a more efficient source of energy 159 with the production of fewer reactive oxygen species compared to glucose metabolism. BHB protects against excitotoxicity 150, by enhancing the conversion of glutamate to GABA and inhibiting glutamate-mediated apoptosis and necrosis by reducing the formation of reactive oxidant species (ROS) 156. Ketones also oxidize coenzyme Q, thereby reducing mitochondrial free radical formation 152. BHB maintains and preserves mitochondrial function by stimulating mitochondrial biogenesis through the upregulation of genes encoding energy metabolism and mitochondrial enzymes 154, 158. The ability of BHB to reduce NAD favors reduction of glutathione, which ultimately leads to the destruction of hydrogen peroxide. Cerebral ketone uptake also increases cerebral blood flow and reduces cell death from apoptosis through reductions in activation and accumulation of caspase-3 ad clusterin, respectively, as well as increases in calbindin. Ketone esters are an exogenous source of BHB bound to a ketone precursor such as butanediol or glycerol that can rapidly raise BHB concentrations in the body to 3-6 mM within 30 minutes. As a molecule that readily crosses the blood brain barrier, BHB can be available to the injured brain after a concussion.

In an exemplary embodiment, BHB or a BHB precursor is present in a daily dose of the nutritional health supplement contemplated herein in an amount of about 500 mg to about 11,000 mg, for example, about 550 mg to about 10,000 mg, such as about 600 mg to about 9,000 mg. In another exemplary embodiment, BHB or a BHB precursor is present in a daily dose of the nutritional health supplement in an amount of about 650 mg to about 8,000 mg, for example, about 700 mg to about 7,000 mg, such as about 750 mg to about 6,000 mg. In another exemplary embodiment, BHB or a BHB precursor is present in a daily dose of the nutritional health supplement in an amount of about 800 mg to about 5,000 mg, for example, about 850 mg to about 4,000 mg, such as about 900 mg to about 3,000 mg. In another exemplary embodiment, BHB or a BHB precursor is present in a daily dose of the nutritional health supplement in an amount of about 950 mg to about 2,500 mg, for example, about 1,000 mg to about 2,000 mg.

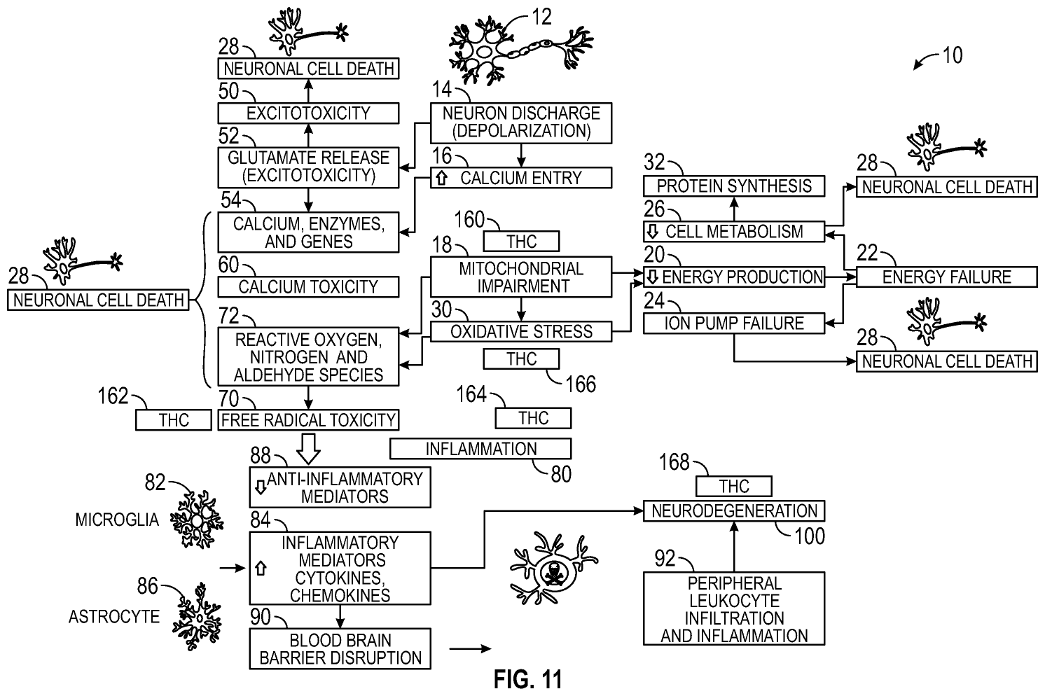

In an exemplary embodiment, the nutritional supplement contemplated herein comprises, but is not limited to, a mitochondrial dysfunction mitigator with antioxidant and anti-inflammatory properties. While any mitochondrial dysfunction mitigator with antioxidant and anti-inflammatory properties is contemplated herein, an example of a suitable mitochondrial dysfunction mitigator with antioxidant and anti-inflammatory properties is curcumin and/or a curcumin derivative, for example, tetrahydroxycurcumin, or a combination thereof. Curcumin is a golden pigment and the biologically active ingredient from the spice herb turmeric. Tetrahydroxycurcumin is the active metabolite that gives curcumin its therapeutic properties. In the setting of concussion, as illustrated in FIG. 11, curcumin mitigates mitochondrial dysfunction 160 and oxidative stress 166 and exerts both antioxidant 162 and anti-inflammatory 164 properties. Curcumin also normalizes levels of brain-derived neurotrophic factor (BDNF) and other effector molecules (e.g., synapsin I) that facilitate synaptic transmission, neuroplasticity 168, and prevent cognitive dysfunction after concussion. Curcumin also modulates several inflammatory pathways primarily through its inhibition of the IkB kinase signaling complex, thereby preventing the activation and release of many proinflammatory cytokines. In addition, curcumin is also involved in cellular energy production and energy homeostasis by increasing mitochondrial proteins and other mitochondrial molecules involved in intracellular calcium homeostasis, oxidative phosphorylation, and energy production. In this way, curcumin may attenuate the energy crisis with brain cells and the secondary injury cascades associated with concussion.

In an exemplary embodiment, the curcumin or tetrahydroxycurcumin is present in a daily dose of the nutritional health supplement contemplated herein in an amount of about 500 mg to about 2000 mg, for example, about 500 mg to about 1500 mg, such as about 500 mg to about 1000 mg. In another exemplary embodiment, curcumin or tetrahydroxycurcumin is present in a daily dose of the nutritional health supplement contemplated herein in an amount of about 500 mg to about 950 mg, for example, about 500 mg to about 900 mg, such as about 500 mg to about 850 mg. In another exemplary embodiment, curcumin or tetrahydroxycurcumin is present in a daily dose of the nutritional health supplement contemplated herein in an amount of about 500 mg to about 800 mg, for example, about 500 mg to about 750 mg, such as about 500 mg to 700 mg. In another exemplary embodiment, curcumin or tetrahydroxycurcumin is present in a daily dose of the nutritional health supplement contemplated herein in an amount of about 500 mg to 650 mg, for example, about 500 mg to about 600 mg, such as about 500 mg to about 550 mg. In another exemplary embodiment, curcumin or tetrahydroxycurcumin is present in a daily dose of the nutritional health supplement contemplated herein in an amount of about 500 mg

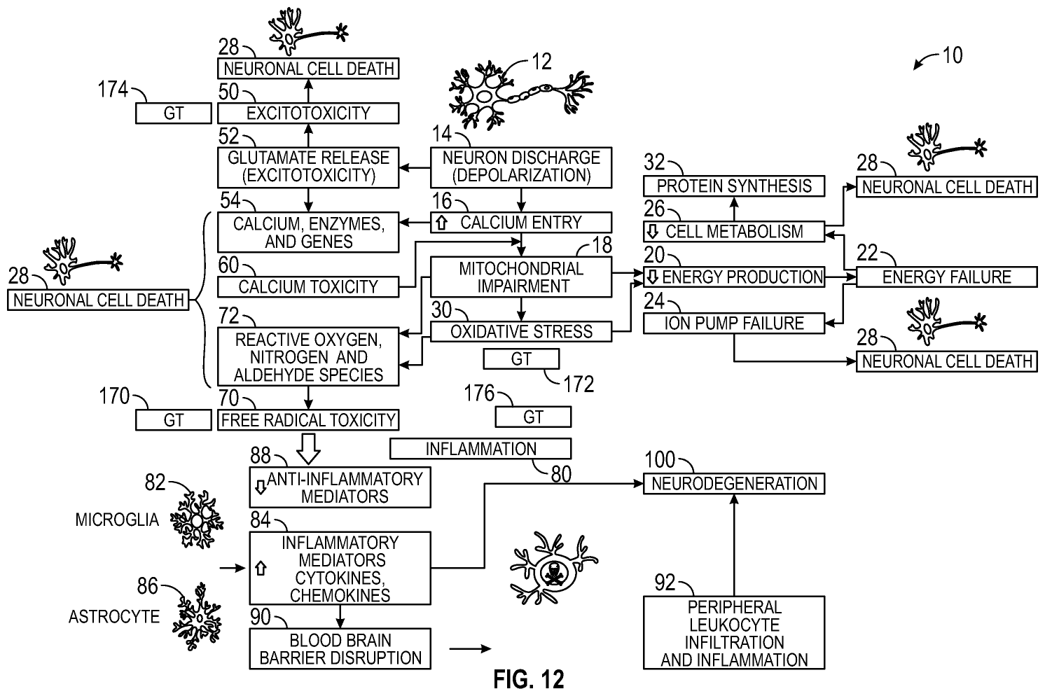

The nutritional health supplement contemplated herein comprises, but is not limited to, an antioxidant with free-radical species-deactivating properties, in accordance with another exemplary embodiment. While various antioxidants with free-radical species-deactivating properties are suitable for use in the nutritional health supplement contemplated herein, in an exemplary embodiment, the antioxidant with free-radical species-deactivating properties comprises glutathione. Referring to FIG. 12, glutathione is a tripeptide and essential antioxidant that protects neurons and vital intracellular structures against free radicals 170 including reactive oxygen species, peroxides, and lipid peroxides. In addition to deactivating free radical species, glutathione is involved in thiol protection and redox regulation of cellular thiol proteins under oxidative stress by protein 172 and mitigates neuroinflammation 176. Glutathione may also be a neuromodulator by modulating the redox state of the NMDA receptor complex and in this way, may attenuate the excitotoxity associated with the release of glutamate that occurs after concussion 174. Glutathione and its precursors are decreased in the brain following a concussion, particularly in the hippocampi. After an acute brain injury, the vascular damage, meningeal cell death, and the generation of reactive oxygen species (ROS) that ultimately breach the glial limitans and promote spread of the injury into the parenchyma, is inhibited by glutathione. In another exemplary embodiment, the nutritional supplement contemplated herein comprises S-acetyl-glutathione. S-acetyl-glutathione is an acetylated form of oral glutathione with optimal absorption and efficacy.

In an exemplary embodiment, S-acetyl glutathione is present in a daily dose of the nutritional health supplement contemplated herein in an amount of about 500 mg to about 4000 mg, for example, about 500 mg to about 3500 mg, such as about 500 mg to about 3000 mg. In another exemplary embodiment, S-acetyl glutathione is present in a daily dose of the nutritional health supplement contemplated herein in an amount of about 500 mg to about 2500 mg, for example, about 500 mg to about 2000 mg, such as about 500 mg to about 1500 mg. In another exemplary embodiment, S-acetyl glutathione is present in a daily dose of the nutritional health supplement contemplated herein in an amount of about 500 mg to about 1000 mg.

In accordance with another exemplary embodiment, a method for attenuating or mitigating a brain injury is provided. The method comprises administering a therapeutically effective amount of a nutritional health supplement to a vertebrate or invertebrate. In an embodiment, the nutritional health supplement comprises an antioxidant that delays neuronal death under excitotoxic conditions, a neuroprotective agent having antioxidant, anti-inflammatory, and anti-apoptic properties, and a neuroprotective agent that is a precursor for glutathione synthesis. In another exemplary embodiment, the nutritional health supplement comprises an antioxidant that delays neuronal death under excitotoxic conditions, a neuroprotective agent that is a precursor for glutathione synthesis, a NAD+ precursor, a ketone body or ketone precursor, and an antioxidant with free-radical species-deactivating properties. In yet another exemplary embodiment, the nutritional health supplement comprises an antioxidant that delays neuronal death under excitotoxic conditions, a neuroprotective agent that is a precursor for glutathione synthesis, a NAD+ precursor, a ketone body or ketone precursor, a BCAA, and an antioxidant with free-radical species-deactivating properties. In a further exemplary embodiment, the nutritional health supplement comprises an antioxidant that delays neuronal death under excitotoxic conditions, a neuroprotective agent having anti-oxidant, anti-inflammatory, and anti-apoptic properties, a neuroprotective agent that is a precursor for glutathione synthesis, a NAD+ precursor, a ketone body or ketone precursor, a BCAA, a neuroprotective agent that mitigates glutamate-mediated excitotoxicity and calcium influx, a mitochondrial-dysfunction mitigator with anti-oxidant and anti-inflammatory properties, and an antioxidant with free-radical species-deactivating properties.

It will be appreciated that the exemplary embodiments of the nutritional health supplements contemplated herein can be presented and administered to oneself or to another vertebrate or invertebrate in any suitable form. For example, the nutritional health supplements contemplated herein can be in the form of a solid such that it can be administered or ingested orally as a pill, tablet, capsule, chewy or gummy supplement, gum, powder, for example, to be mixed in a liquid or drink, or the like. Alternatively, the nutritional health supplements as contemplated herein can be in the form of a liquid, so as to be administered subcutaneously, intravenously, as a liquid oral spoonful or shot, or via intranasal administration. Of course, other methods of administration of the nutritional health supplements contemplated herein also may be used, such as, for example, transdermally. It also will be understood herein that the term “daily dose” refers to one or more administrations of the nutritional health supplement, for example, one or more pills, one or more tablets, one or more liquid spoonfuls or shots, etc. in a 24-hour period.

As noted above, the natural health supplements contemplated herein are effective for both the attenuation and mitigation of brain injury. Accordingly, the administration of the nutritional health supplements can be affected before activity that may result in a concussion, for example, a sport, during activity that potentially could result in a concussion, and/or as soon as possible upon a suspected or confirmed concussion. For example, in one embodiment, one of the exemplary embodiments of the nutritional health supplement contemplated herein is taken in a daily dose for a period, such as, for example, two weeks, one month or the like, prior to the participation in a high-risk activity, or a series of high-risk activities, such as a sports season.

In another embodiment, a nutritional health supplement as contemplated herein is administered in discrete daily doses during periods of exposure to repetitive hits to the head, such as during a sports season. Exposure is highest in numerous contact and non-contact sports during practice and game activities. Youth and adult athletes who participate in contact sports sustain hundreds to thousands of hits to the head during an athletic season, depending on the sport and position of play. In the absence of symptoms or signs of concussion, these “sub-concussive” hits result in both functional and structural injury to the brain. Sub-concussive hits (or silent concussions) initiate the same pathophysiological events of a symptomatic concussion. Sub-concussive hits result in the same long-term neurological consequences as symptomatic concussions. Therefore, the daily use of an exemplary embodiment of the nutritional health supplement as contemplated herein during this exposure period will optimize the health of the brain, and enhance the protection of the brain, mitigate the damage to brain tissue, and enhance the repair mechanisms necessary because of these silent brain injuries.

In another embodiment, a nutritional health supplement as contemplated herein is administered in daily doses as soon as possible upon a suspected or confirmed concussion. Restoration of normal metabolic activity takes approximately 30 days after a single concussion. For example, a nutritional health supplement as contemplated herein is administered immediately or as soon as possible after a concussion and taken in daily doses for 30 days after a single concussion, or 60 days if there is a second concussion with 30 days after the first. The immediate administration after the contact is optimal. However, administration within 24 hours can substantially mitigate the injury and enhance the speed of recovery. Benefits of the nutritional health supplements contemplated herein may also be observed if the supplements are taken after 24 hours of the injury.

The various embodiments of the nutritional health supplement as contemplated herein can be taken in series at various times with respect to a potential or actual concussion. In one exemplary embodiment, a nutritional health supplement as contemplated herein comprising an antioxidant that delays neuronal death under excitotoxic conditions, a neuroprotective agent having anti-oxidant, anti-inflammatory, and anti-apoptic properties, and a neuroprotective agent that is a precursor for glutathione synthesis is taken before and/or during the period of exposure to repetitive hits to the head, such as during a sports season, to optimize the health of the brain, and enhance the protection of the brain. In another embodiment, a nutritional health supplement as contemplated herein comprising an antioxidant that delays neuronal death under excitotoxic conditions, a neuroprotective agent that is a precursor for glutathione synthesis, a NAD+ precursor, a ketone body or ketone precursor, and an antioxidant with free-radical species-deactivating properties is taken before and/or during the period of exposure to repetitive hits to the head, such as during a sports season, to optimize the health of the brain, and enhance the protection of the brain.

After a concussion, administration of this embodiment of the nutritional supplement is halted and an embodiment of the nutritional health supplement comprising an antioxidant that delays neuronal death under excitotoxic conditions, a neuroprotective agent having anti-oxidant, anti-inflammatory, and anti-apoptic properties, a neuroprotective agent that is a precursor for glutathione synthesis, a NAD+ precursor, a ketone body or ketone precursor, a BCAA, a neuroprotective agent that mitigates glutamate-mediated excitotoxicity and calcium influx, a mitochondrial-dysfunction mitigator with anti-oxidant and anti-inflammatory properties, and an antioxidant with free-radical species-deactivating properties is administered for approximately 30 days after a single concussion. Alternatively, an embodiment of the nutritional health supplement comprising an antioxidant that delays neuronal death under excitotoxic conditions, a neuroprotective agent that is a precursor for glutathione synthesis, a NAD+ precursor, a ketone body or ketone precursor, a BCAA, and an antioxidant with free-radical species-deactivating properties is administered for approximately 30 days after a single concussion. Restoration of normal metabolic activity takes approximately 30 days after a single concussion. Therefore, this nutritional health supplement is administered immediately or as soon as possible after a concussion and taken for 30 days after a single concussion, or 60 days if there is a second concussion with 30 days after the first.

As can be appreciated from the foregoing, description, these natural components that form the basis of the nutritional health supplements as contemplated herein address numerous factors of excitotoxicity, calcium-mediated toxicity, free radical toxicity, neuroinflammation, oxidative stress, protein synthesis, and neurodegeneration that are specifically stated herein. Additional benefits are not provided in the interest of brevity and clarity, and the stated, implied, and unstated benefits are applicable to other conditions, characterized by neuroinflammation, including concussion, stroke, cancer, infections of blood, brain, and other organs, autoimmunity and autoimmune brain diseases including multiple sclerosis and other demyelinating diseases, migraine and other primary and secondary headache disorders, neurodegenerative diseases including Parkinson's Disease, Huntington's Disease and Amyotrophic Lateral Sclerosis and other motor neuron diseases, and dementia syndromes, including Alzheimer's Disease and Chronic Traumatic Encephalopathy (CTE).

The following combinations are not exhaustive and provided only as exemplary embodiments. It will be appreciated that many other embodiments with various combinations of ingredients and amounts of ingredients are possible and are contemplated herein.

### Exemplary Embodiment 1

A nutritional health supplement for attenuating or mitigating concussion including, per daily dose of the nutritional health supplement:
riboflavin-5′-phosphate in an amount of about 100 mg to about 600 mg;
resveratrol in an amount of about 250 mg to about 500 mg; and
N-acetyl cysteine in an amount of about 400 mg to about 1000 mg.

### Exemplary Embodiment 2

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg; and
nicotinamide riboside in an amount of about 400 mg to 900 mg.

### Exemplary Embodiment 3

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg; and
betahydroxybutyrate or a betahydroxybutyrate precursor in an amount of about 900 to about 3000 mg.

### Exemplary Embodiment 4

A nutritional supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg; and
L-leucine in an amount of about 2400 mg to about 2600 mg.

### Exemplary Embodiment 5

A nutritional supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg; and
L-isoleucine in an amount of about 1150 mg to about 1350 mg.

### Exemplary Embodiment 6

A nutritional supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg; and
L-valine in an amount of about 1150 mg to about 1350 mg.

### Exemplary Embodiment 7

A nutritional supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
L-leucine in an amount of about 2400 mg to about 2600 mg; and
L-valine and/or L-isoleucine in an amount of about 1150 mg to about 1350 mg.

### Exemplary Embodiment 8

A nutritional supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg; and
omega-3 fatty acid docosahexaenoic acid in an amount of about 1,700 mg to about 3,500 mg.

### Exemplary Embodiment 9

A nutritional supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg; and
curcumin or tetrahydroxycurcumin in an amount of about 500 to about 1000 mg.

### Exemplary Embodiment 10

A nutritional supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg; and
S-acetyl glutathione in an amount of about 500 mg to about 2000 mg.

### Exemplary Embodiment 11

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg; and
betahydroxybutyrate or a betahydroxybutyrate precursor in an amount of about 900 to about 3000 mg.

### Exemplary Embodiment 12

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg; and
L-leucine in an amount of about 2400 mg to about 2600 mg.

### Exemplary Embodiment 13

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg; and
L-isoleucine in an amount of about 1150 mg to about 13500 mg.

### Exemplary Embodiment 14

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg; and
L-valine in an amount of about 1150 mg to about 13500 mg.

### Exemplary Embodiment 15

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-leucine in an amount of about 2400 mg to about 2600 mg; and
L-valine and/or L-isoleucine in an amount of about 1150 mg to about 13500 mg.

### Exemplary Embodiment 16

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg; and
omega-3 fatty acid docosahexaenoic acid in an amount of about 1,700 mg to about 3,500 mg.

### Exemplary Embodiment 17

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg; and
curcumin or tetrahydroxycurcumin in an amount of about 500 to about 1000 mg.

### Exemplary Embodiment 18

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg; and
S-acetyl glutathione in an amount of about 500 mg to about 2000 mg.

### Exemplary Embodiment 19

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
betahydroxybutyrate or a betahydroxybutyrate precursor in an amount of about 900 to 3000 mg; and
L-leucine in an amount of about 2400 mg to about 2600 mg.

### Exemplary Embodiment 20

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
betahydroxybutyrate or a betahydroxybutyrate precursor in an amount of about 900 to 3000 mg; and
L-isoleucine in an amount of about 1150 mg to about 1350 mg.

### Exemplary Embodiment 21

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
betahydroxybutyrate or a betahydroxybutyrate precursor in an amount of about 900 to 3000 mg; and
L-valine in an amount of about 1150 mg to about 1350 mg.

### Exemplary Embodiment 22

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
betahydroxybutyrate or a betahydroxybutyrate precursor in an amount of about 900 to 3000 mg;
L-leucine in an amount of about 2400 mg to about 2600 mg; and
L-valine and/or L-isoleucine in an amount of about 1150 mg to about 1350 mg.

### Exemplary Embodiment 23

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
betahydroxybutyrate or a betahydroxybutyrate precursor in an amount of about 900 to 3000 mg; and
omega-3 fatty acid docosahexaenoic acid in an amount of about 1700 mg to about 3500 mg.

### Exemplary Embodiment 24

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
betahydroxybutyrate or a betahydroxybutyrate precursor in an amount of about 900 to 3000 mg; and
curcumin or tetrahydroxycurcumin in an amount of about 500 to about 1000 mg.

### Exemplary Embodiment 25

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
betahydroxybutyrate or a betahydroxybutyrate precursor in an amount of about 900 to 1100 mg; and
S-acetyl glutathione in an amount of about 500 mg to about 2000 mg.

### Exemplary Embodiment 26

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
L-leucine in an amount of about 2400 mg to about 2600 mg; and
omega-3 fatty acid docosahexaenoic acid in an amount of about 1700 mg to about 3500 mg.

### Exemplary Embodiment 27

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
L-isoleucine in an amount of about 1150 mg to about 1350 mg; and
omega-3 fatty acid docosahexaenoic acid in an amount of about 1700 mg to about 3500 mg.

### Exemplary Embodiment 28

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
L-valine in an amount of about 1150 mg to about 1350 mg; and
omega-3 fatty acid docosahexaenoic acid in an amount of about 1700 mg to about 3500 mg.

### Exemplary Embodiment 29

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
L-leucine in an amount of about 2400 mg to about 2600 mg;
L-valine and/or L-isoleucine in an amount of about 1150 mg to about 1350 mg; and
omega-3 fatty acid docosahexaenoic acid in an amount of about 1700 mg to about 3500 mg.

### Exemplary Embodiment 30

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
L-leucine in an amount of about 2400 mg to about 2600 mg; and
curcumin or tetrahydroxycurcumin in an amount of about 500 mg to about 1000 mg.

### Exemplary Embodiment 31

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
L-isoleucine in an amount of about 1150 mg to about 1350 mg; and
curcumin or tetrahydroxycurcumin in an amount of about 500 mg to about 1000 mg.

### Exemplary Embodiment 32

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
L-valine in an amount of about 1150 mg to about 1350 mg; and
curcumin or tetrahydroxycurcumin in an amount of about 500 mg to about 1000 mg.

### Exemplary Embodiment 33

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
L-leucine in an amount of about 2400 mg to about 2600 mg; and
L-valine and/or L-isoleucine in an amount of about 1150 mg to about 1350 mg; and
curcumin or tetrahydroxycurcumin in an amount of about 500 mg to about 1000 mg.

### Exemplary Embodiment 34

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
L-leucine in an amount of about 2400 mg to about 2600 mg; and
S-acetyl glutathione in an amount of about 500 mg to about 2000 mg.

### Exemplary Embodiment 35

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
L-isoleucine in an amount of about 1150 mg to about 1350 mg; and
S-acetyl glutathione in an amount of about 500 mg to about 2000 mg.

### Exemplary Embodiment 36

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
L-valine in an amount of about 1150 mg to about 1350 mg; and
S-acetyl glutathione in an amount of about 500 mg to about 2000 mg.

### Exemplary Embodiment 37

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
L-leucine in an amount of about 2400 mg to about 2600 mg;
L-valine and/or L-isoleucine in an amount of about 1150 mg to about 1350 mg; and
S-acetyl glutathione in an amount of about 500 mg to about 2000 mg.

### Exemplary Embodiment 38

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
omega-3 fatty acid docosahexaenoic acid in an amount of about 1700 mg to about 3500 mg; and
curcumin or tetrahydroxycurcumin in an amount of about 400 mg to about 600 mg.

### Exemplary Embodiment 39

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
omega-3 fatty acid docosahexaenoic acid in an amount of about 1700 mg to about 3500 mg; and
S-acetyl glutathione in an amount of about 500 mg to about 2000 mg.

### Exemplary Embodiment 40

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
curcumin or tetrahydroxycurcumin in an amount of about 500 mg to about 1000 mg; and
S-acetyl glutathione in an amount of about 500 mg to about 2000 mg.

### Exemplary Embodiment 41

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to about 3000 mg; and
L-leucine in an amount of about 2400 mg to about 2600 mg.

### Exemplary Embodiment 42

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to about 3000 mg; and
L-isoleucine in an amount of about 1150 mg to about 1350 mg.

### Exemplary Embodiment 43

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to about 3000 mg; and
L-valine in an amount of about 1150 mg to about 1350 mg.

### Exemplary Embodiment 44

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to about 3000 mg;
L-leucine in an amount of about 2400 mg to about 2600 mg; and
L-valine and/or L-isoleucine in an amount of about 1150 mg to about 1350 mg.

### Exemplary Embodiment 45

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to about 3000 mg; and
omega-3 fatty acid docosahexaenoic acid in an amount of about 1700 mg to about 3500 mg.

### Exemplary Embodiment 46

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to about 3000 mg; and
curcumin or tetrahydroxycurcumin in an amount of about 500 mg to about 1000 mg.

### Exemplary Embodiment 47

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to about 3000 mg; and
S-acetyl glutathione in an amount of about 500 mg to about 2000 mg.

### Exemplary Embodiment 48

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-leucine in an amount of about 2400 mg to about 2600 mg; and
omega-3 fatty acid docosahexaenoic acid in an amount of about 1700 mg to about 3500 mg.

### Exemplary Embodiment 49

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-isoleucine and/or L-valine in an amount of about 1150 mg to about 1350 mg; and
omega-3 fatty acid docosahexaenoic acid in an amount of about 1700 mg to about 3500 mg.

### Exemplary Embodiment 50

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-leucine in an amount of about 2400 mg to about 2600 mg;
L-isoleucine and/or L-valine in an amount of about 1150 mg to about 1350 mg; and
omega-3 fatty acid docosahexaenoic acid in an amount of about 1700 mg to about 3500 mg.

### Exemplary Embodiment 51

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-leucine in an amount of about 2400 mg to about 2600 mg; and
curcumin or tetrahydroxycurcumin in an amount of about 500 mg to about 1000 mg.

### Exemplary Embodiment 52

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-isoleucine and/or L-valine in an amount of about 1150 mg to about 1350 mg; and
curcumin or tetrahydroxycurcumin in an amount of about 500 mg to about 1000 mg.

### Exemplary Embodiment 53

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-leucine in an amount of about 2400 mg to about 2600 mg
L-isoleucine and/or L-valine in an amount of about 1150 mg to about 1350 mg; and
curcumin or tetrahydroxycurcumin in an amount of about 500 mg to about 1000 mg.

### Exemplary Embodiment 54

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-leucine in an amount of about 2400 mg to about 2600 mg; and
S-acetyl glutathione in an amount of about 500 mg to about 2000 mg.

### Exemplary Embodiment 55

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-isoleucine or L-valine in an amount of about 1150 mg to about 1350 mg; and
S-acetyl glutathione in an amount of about 500 mg to about 2000 mg.

### Exemplary Embodiment 56

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-leucine in an amount of about 2400 mg to about 2600 mg;
L-isoleucine and/or L-valine in an amount of about 1150 mg to about 1350 mg; and
S-acetyl glutathione in an amount of about 500 mg to about 2000 mg.

### Exemplary Embodiment 57

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
omega-3 fatty acid docosahexaenoic acid in an amount of about 1700 mg to about 3500 mg; and
curcumin or tetrahydroxycurcumin in an amount of about 500 mg to about 1000 mg.

### Exemplary Embodiment 58

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
omega-3 fatty acid docosahexaenoic acid in an amount of about 1700 mg to about 3500 mg; and
S-acetyl glutathione in an amount of about 500 mg to about 2000 mg.

### Exemplary Embodiment 59

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
curcumin or tetrahydroxycurcumin in an amount of about 500 mg to about 1000 mg; and
S-acetyl glutathione in an amount of about 500 mg to about 2000 mg.

### Exemplary Embodiment 60

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-leucine in an amount of about 2400 mg to about 2600 mg;
omega-3 fatty acid docosahexaenoic acid in an amount of about 1700 mg to about 3500 mg; and
curcumin or tetrahydroxycurcumin in an amount of about 500 mg to about 1000 mg.

### Exemplary Embodiment 61

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-isoleucine or L-valine in an amount of about 1150 mg to about 1350 mg;
omega-3 fatty acid docosahexaenoic acid in an amount of about 1700 mg to about 3500 mg; and
curcumin or tetrahydroxycurcumin in an amount of about 500 mg to about 1000 mg.

### Exemplary Embodiment 62

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-leucine in an amount of about 2400 mg to about 2600 mg;
L-isoleucine and/or L-valine in an amount of about 1150 mg to about 1350 mg;
omega-3 fatty acid docosahexaenoic acid in an amount of about 1700 mg to about 3500 mg; and
curcumin or tetrahydroxycurcumin in an amount of about 500 mg to about 1000 mg.

### Exemplary Embodiment 63

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-leucine in an amount of about 2400 mg to about 2600 mg;
omega-3 fatty acid docosahexaenoic acid in an amount of about 1700 mg to about 3500 mg; and
S-acetyl glutathione in an amount of about 500 mg to about 2000 mg.

### Exemplary Embodiment 64

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-isoleucine and/or L-valine in an amount of about 1150 mg to about 1350 mg;
omega-3 fatty acid docosahexaenoic acid in an amount of about 1700 mg to about 3500 mg; and
S-acetyl glutathione in an amount of about 500 mg to about 2000 mg.

### Exemplary Embodiment 65

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
L-leucine in an amount of about 2400 mg to about 2600 mg;
L-isoleucine and/or L-valine in an amount of about 1150 mg to about 1350 mg;
omega-3 fatty acid docosahexaenoic acid in an amount of about 1700 mg to about 3500 mg; and
S-acetyl glutathione in an amount of about 500 mg to about 2000 mg.

### Exemplary Embodiment 66

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-leucine in an amount of about 2400 mg to about 2600 mg;
omega-3 fatty acid docosahexaenoic acid in an amount of about 1700 mg to about 3500 mg; and
curcumin or tetrahydroxycurcumin in an amount of about 500 mg to about 1000 mg.

### Exemplary Embodiment 67

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg
L-isoleucine and/or L-valine in an amount of about 1150 mg to about 1350 mg;
omega-3 fatty acid docosahexaenoic acid in an amount of about 1700 mg to about 3500 mg; and
curcumin or tetrahydroxycurcumin in an amount of about 500 mg to about 1000 mg.

### Exemplary Embodiment 68

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-leucine in an amount of about 2400 mg to about 2600 mg;
L-isoleucine and/or L-valine in an amount of about 1150 mg to about 1350 mg;
omega-3 fatty acid docosahexaenoic acid in an amount of about 1700 mg to about 3500 mg; and
curcumin or tetrahydroxycurcumin in an amount of about 500 mg to about 1000 mg.

### Exemplary Embodiment 69

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-leucine in an amount of about 2400 mg to about 2600 mg;
omega-3 fatty acid docosahexaenoic acid in an amount of about 1700 mg to about 3500 mg; and
S-acetyl glutathione in an amount of about 500 mg to about 2000 mg.

### Exemplary Embodiment 70

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg
L-isoleucine or L-valine in an amount of about 1150 mg to about 1350 mg;
omega-3 fatty acid docosahexaenoic acid in an amount of about 1700 mg to about 3500 mg; and
S-acetyl glutathione in an amount of about 500 mg to about 2000 mg.

### Exemplary Embodiment 71

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-leucine in an amount of about 2400 mg to about 2600 mg;
L-isoleucine and/or L-valine in an amount of about 1150 mg to about 1350 mg;
omega-3 fatty acid docosahexaenoic acid in an amount of about 1700 mg to about 3500 mg; and
S-acetyl glutathione in an amount of about 500 mg to about 2000 mg.

### Exemplary Embodiment 72

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg
L-leucine in an amount of about 2400 mg to about 2600 mg;
omega-3 fatty acid docosahexaenoic acid in an amount of about 1700 mg to about 3500 mg;
curcumin or tetrahydroxycurcumin in an amount of about 500 mg to about 1000 mg; and
S-acetyl glutathione in an amount of about 500 mg to about 2000 mg.

### Exemplary Embodiment 73

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg
L-isoleucine or L-valine in an amount of about 1150 mg to about 1350 mg;
omega-3 fatty acid docosahexaenoic acid in an amount of about 1700 mg to about 3500 mg;
curcumin or tetrahydroxycurcumin in an amount of about 500 mg to about 1000 mg; and
S-acetyl glutathione in an amount of about 500 mg to about 2000 mg.

### Exemplary Embodiment 74

A nutritional health supplement for attenuating or mitigating concussion including, per daily dose of the nutritional health supplement:
riboflavin in an amount of about 100 mg to about 600 mg;
resveratrol in an amount of about 250 mg to about 500 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-leucine in an amount of about 2400 mg to about 2600 mg;
L-isoleucine and/or L-valine in an amount of about 1150 mg to about 1350 mg;
omega-3 fatty acid docosahexaenoic acid in an amount of about 1700 mg to about 3500 mg;
curcumin or tetrahydroxycurcumin in an amount of about 500 mg to about 1000 mg; and
S-acetyl glutathione in an amount of about 500 mg to about 2000 mg.

### Exemplary Embodiment 75

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg; and
S-acetyl glutathione in an amount of about 500 mg to about 2000 mg.

### Exemplary Embodiment 76

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-leucine in an amount of about 2400 mg to about 2600 mg; and
S-acetyl glutathione in an amount of about 500 mg to about 2000 mg.

### Exemplary Embodiment 77

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg
L-isoleucine and/or L-valine in an amount of about 1150 mg to about 1350 mg; and
S-acetyl glutathione in an amount of about 500 mg to about 2000 mg.

### Exemplary Embodiment 78

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-leucine in an amount of about 2400 mg to about 2600 mg;
L-isoleucine and/or L-valine in an amount of about 1150 mg to about 1350 mg; and
S-acetyl glutathione in an amount of about 500 mg to about 2000 mg.

### Exemplary Embodiment 79

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
S-acetyl glutathione in an amount of about 500 mg to about 2000 mg; and
omega-3 fatty acid docosahexaenoic acid in an amount of about 1700 mg to about 3500 mg.

### Exemplary Embodiment 80

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
S-acetyl glutathione in an amount of about 500 mg to about 2000 mg; and
curcumin or tetrahydroxycurcumin in an amount of about 500 mg to about 1000 mg.

### Exemplary Embodiment 81

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
S-acetyl glutathione in an amount of about 500 mg to about 2000 mg;
omega-3 fatty acid docosahexaenoic acid in an amount of about 1700 mg to about 3500 mg; and
curcumin or tetrahydroxycurcumin in an amount of about 500 mg to about 1000 mg.

### Exemplary Embodiment 82

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-leucine in an amount of about 2400 mg to about 2600 mg;
omega-3 fatty acid docosahexaenoic acid in an amount of about 1700 mg to about 3500 mg; and
S-acetyl glutathione in an amount of about 500 mg to about 2000 mg.

### Exemplary Embodiment 83

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-isoleucine and/or L-valine in an amount of about 1150 mg to about 1350 mg;
omega-3 fatty acid docosahexaenoic acid in an amount of about 1700 mg to about 3500 mg; and
S-acetyl glutathione in an amount of about 500 mg to about 2000 mg.

### Exemplary Embodiment 84

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-leucine in an amount of about 2400 mg to about 2600 mg;
L-isoleucine and/or L-valine in an amount of about 1150 mg to about 1350 mg;
omega-3 fatty acid docosahexaenoic acid in an amount of about 1700 mg to about 3500 mg; and
S-acetyl glutathione in an amount of about 500 mg to about 2000 mg.

### Exemplary Embodiment 85

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-leucine in an amount of about 2400 mg to about 2600 mg;
curcumin or tetrahydroxycurcumin in an amount of about 500 mg to about 1000 mg; and
S-acetyl glutathione in an amount of about 500 mg to about 2000 mg.

### Exemplary Embodiment 86

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-isoleucine and/or L-valine in an amount of about 1150 mg to about 1350 mg; curcumin or tetrahydroxycurcumin in an amount of about 500 mg to about 1000 mg; and
S-acetyl glutathione in an amount of about 500 mg to about 2000 mg.

### Exemplary Embodiment 87

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-leucine in an amount of about 2400 mg to about 2600 mg;
L-isoleucine and/or L-valine in an amount of about 1150 mg to about 1350 mg; curcumin or tetrahydroxycurcumin in an amount of about 500 mg to about 1000 mg; and
S-acetyl glutathione in an amount of about 500 mg to about 2000 mg.

### Exemplary Embodiment 88

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-leucine in an amount of about 2400 mg to about 2600 mg;
omega-3 fatty acid docosahexaenoic acid in an amount of about 1700 mg to about 3500 mg;
curcumin or tetrahydroxycurcumin in an amount of about 500 mg to about 1000 mg and
S-acetyl glutathione in an amount of about 500 mg to about 2000 mg.

### Exemplary Embodiment 89

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-isoleucine and/or L-valine in an amount of about 1150 mg to about 1350 mg;
omega-3 fatty acid docosahexaenoic acid in an amount of about 1700 mg to about 3500 mg;
curcumin or tetrahydroxycurcumin in an amount of about 500 mg to about 1000 mg and
S-acetyl glutathione in an amount of about 500 mg to about 2000 mg.

### Exemplary Embodiment 90

A nutritional health supplement for attenuating or mitigating concussion including, per daily dose of the nutritional health supplement:
riboflavin in an amount of about 100 mg to about 600 mg;
N-acetyl cysteine in an amount of about 400 mg to about 1000 mg;
nicotinamide riboside in an amount of about 400 mg to 900 mg;
betahydroxybutyrate or a betahydroxybutyrate precursor in an amount of about 900 to 3000 mg;
L-leucine in an amount of about 2400 mg to about 2600 mg;
L-isoleucine and/or L-valine in an amount of about 1150 mg to about 1350 mg;
omega-3 fatty acid docosahexaenoic acid in an amount of about 1700 mg to about 3500 mg;
curcumin or tetrahydroxycurcumin in an amount of about 500 mg to about 1000 mg; and
S-acetyl glutathione in an amount of about 500 mg to about 2000 mg.

What is claimed is:

1. A nutritional health supplement, comprising:
an antioxidant that delays neuronal death under excitotoxic conditions;
a neuroprotective agent having antioxidant, anti-inflammatory, and anti-apoptic properties; and
a neuroprotective agent that is a precursor for glutathione synthesis.

2. The nutritional health supplement of claim 1, wherein the antioxidant that delays neuronal death under excitotoxic conditions comprises riboflavin.

3. The nutritional health supplement of claim 1, wherein the neuroprotective agent having antioxidant, anti-inflammatory, and anti-apoptic properties comprises resveratrol.

4. The nutritional health supplement of claim 1, wherein the neuroprotective agent that is a precursor for glutathione synthesis comprises N-acetyl cysteine.

5. The nutritional health supplement of claim 1, further comprising a NAD+ precursor.

6. The nutritional health supplement of claim 9, wherein the NAD+ precursor comprises nicotinamide riboside.

7. The nutritional health supplement of claim 1, further comprising a ketone body or a ketone precursor.

8. The nutritional health supplement of claim 7, wherein the ketone body or ketone precursor comprises betahydroxybutyrate or a betahydroxybutyrate precursor.

9. The nutritional health supplement of claim 1, further comprising a branched chain amino acid.

10. The nutritional health supplement of claim 1, further comprising a neuroprotective agent that mitigates glutamate-mediated excitotoxicity and calcium influx.

11. The nutritional health supplement of claim 10, wherein the neuroprotective agent that mitigates glutamate-mediated excitotoxicity and calcium influx comprises omega-3 fatty acid docosahexaenoic acid.

12. The nutritional health supplement of claim 1, further comprising a mitochondrial dysfunction mitigator with antioxidant and anti-inflammatory properties.

13. The nutritional health supplement of claim 12, wherein the mitochondrial dysfunction mitigator with antioxidant and anti-inflammatory properties comprises curcumin or tetrahydroxycurcumin.

14. The nutritional health supplement of claim 1, further comprising an antioxidant with free-radical species-deactivating properties.

15. The nutritional health supplement of claim 14, wherein the antioxidant with free-radical species-deactivating properties comprises glutathione.

16. The nutritional health supplement of claim 1, wherein the nutritional health supplement is a nutritional brain supplement.

17. The nutritional health supplement of claim 1, wherein the nutritional supplement is taken orally.

18. A nutritional health supplement comprising:
an antioxidant that delays neuronal death under excitotoxic conditions;
a neuroprotective agent that is a precursor for glutathione synthesis;
a NAD+ precursor;
a ketone body or ketone precursor; and
an antioxidant with free-radical species-deactivating properties.

19. The nutritional health supplement of claim 18, further comprising a branched chain amino acid.

20. A nutritional health supplement, comprising:
riboflavin;
N-acetyl cysteine (NAC);
nicotinamide riboside;
betahydroxybutyrate or a betahydroxybutyrate precursor; and
glutathione.
